(19) United States
(12) Patent Application Publication
(10) Pub. No.: US 2017/0213487 A1
(43) Pub. Date: Jul. 27, 2017

(54) Window Shutter Sleeve and Frame

(71) Applicant: Cathy Blommel, Minneapolis, MN (US)

(72) Inventor: Cathy Blommel, Minneapolis, MN (US)

(21) Appl. No.: 15/416,847

(22) Filed: Jan. 26, 2017

Related U.S. Application Data
(60) Provisional application No. 62/287,045, filed on Jan. 26, 2016.

(51) Int. Cl. G09F 19/22

(52) U.S. Cl. CPC G09F 19/22

(57) ABSTRACT

A window shutter sleeve for placement over a window shutter of a home, or a frame in lieu of a window shutter, with an outer side, an inner side, a top lip, a bottom lip, and four edges, the four edges comprising a top edge, a bottom edge, and two side edges, the outer side having a decorative feature. The window shutter sleeve is removably attached to the window shutter or frame in lieu of a shutter by a variety of attaching means including clips, hook and loop fasteners, and elastic bands.

This application claims the filing date of and relates to the provisional application by the same inventor, serial number 62/287,045 filed on Jan. 26, 2016.

### BACKGROUND

The present invention is a window shutter sleeve for covering a window shutter, or for covering a frame in lieu of a window shutter. Often, homeowners desire to change the look of their house, primarily by painting the house a different color, painting the window shutters a different or contrasting color, or changing the window shutters. Such changes can be expensive, and there exist only a limited number of window shutter styles. Painting or replacing the window shutter with another style of window shutter can be expensive and cumbersome. The present invention is an inexpensive, easily changeable window shutter. In addition, where no window shutters exist, a frame can be used for placement of the window shutter sleeve.

### SUMMARY OF INVENTION

The window shutter sleeve comprises a lightweight, plastic cover for placement over a window shutter or a frame in lieu of a window shutter. The window shutter sleeve comprises a decorative face on its outer side, an attaching means, such as, clips, hook and loop fasteners, elastic bands or other similar fasteners, four edges, and an inner side. If elastic bands are used as the fastener, the elastic bands are attached along the sleeve edges, thus allowing the window shutter sleeve to be placed over the window shutter, the elastic bands being situated between the home and the window shutter, thus holding the sleeve in place.

Creating shutters in different sizes, shapes, and colors is not practical, and changing them for different season, holidays, or celebrations would be both impractical and expensive, and changing the shutters in the winter would be extremely difficult. Likewise, it would be difficult to change the holes in the siding with each new decoration.

Using existing shutters as a frame, and putting different designed sleeves on the shutters, is much more practical and less expensive than replacing the existing shutters. It is easy to slide some thin plastic sleeves with design features over existing shutters or over a frame, even in the winter. Sliding on the decorative sleeve, clipping or otherwise fastening it to the shutter or frame, would be all it would take to change the outside appearance or to decorate the outside of a house. Similarly, there is no end to the designs or decorative features that could be used.

The present invention is for a window shutter sleeve that is lightweight, easy to handle, and easy enough for anyone to change or interchange them on their own. The window shutter sleeve will be as thin, or thinner than a cookie sheet, and much lighter so a single person can handle, install, remove, and store it easily.

Both the window shutter sleeve and the frame are easy to attach to any house, building or business, and are easy to change as often as wanted or needed.

### DESCRIPTION OF DRAWINGS

FIG. 1 shows a front view of the frame.

FIG. 2 also shows a side view of the window shutter sleeve.

FIG. 3 shows the window shutter sleeve installed on the frame, with the frame shown as a dotted line behind the window shutter sleeve.

### DETAILED DESCRIPTION

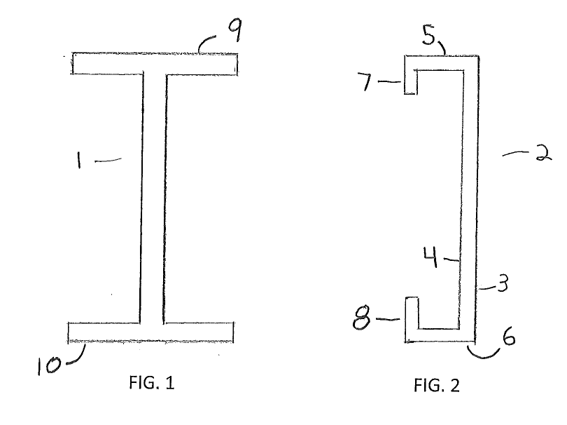

As shown in FIGS. 1 and 2, the frame 1 has an “I” shape and the window shutter sleeve 2 has an outer side 3, an inner side 4, a top lip 5, a bottom lip 6, a top edge 7, and a bottom edge 8. The top edge 7 fits over an upper frame edge 9 and the bottom edge 8 fits over a lower frame edge 10. Fasteners, such as clips, removably fasten the window shutter sleeve at the top edge 7 and bottom edge 8 to the frame. The remaining two side edges of the window shutter sleeve can likewise be fastened to the window shutter or frame. The decorative features (not shown) are displayed on the outer side 3 of the window shutter sleeve 2, and can be a variety of decorative features that can be displayed on the window shutter sleeves.

FIG. 1 is a front view of the frame 1, and FIG. 2 is a side view of the window shutter sleeve 2.

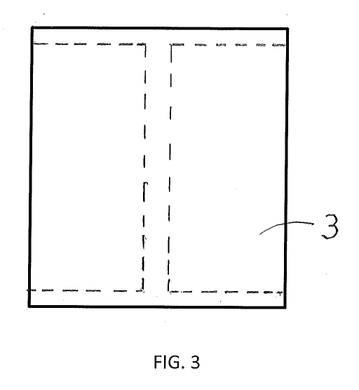

As shown in FIG. 3, the outer side 3 of the window shutter sleeve is planar, allowing the decorative feature to be displayed. The window shutter sleeve can be a variety of sizes, depending upon the size, dimensions, and shape of the window shutter upon which the sleeve is to be placed.

I claim:

1. A window shutter sleeve for placement over a window shutter of a home, or a frame in lieu of a window shutter, comprising an outer side, an inner side, a top lip, a bottom lip, and four edges, the four edges comprising a top edge, a bottom edge, and two side edges.

2. The window shutter sleeve of claim 1 wherein the window shutter sleeve is made of plastic.

3. The window shutter sleeve of claim 1 comprising a decorative feature on its outer side.

4. The window shutter sleeve of claim 1 further comprising an attaching means for removably attaching the window shutter sleeve to the window shutter or frame in lieu of a window shutter.

5. The window shutter sleeve of claim 3 wherein the attaching means is selected from the group consisting of clips and hook and loop fasteners.

6. The window shutter sleeve of claim 3 wherein the attaching means comprise elastic bands attached along the four edges, allowing the window shutter sleeve to be placed over the window shutter, the elastic bands being situated between the home and the window shutter, holding the sleeve in place.

7. The window shutter sleeve of claim 2 wherein the decorative feature is a solid color.

8. The window shutter sleeve of claim 2 wherein the decorative feature comprises geometric lines.

9. The window shutter sleeve of claim 2 wherein the decorative feature comprises geometric shapes.

10. The window shutter sleeve of claim 2 wherein the decorative feature is selected from the group consisting of letters, words and numbers.

11. The window shutter sleeve of claim 2 wherein the decorative feature comprises a design.

12. The window shutter sleeve of claim 2 wherein the decorative feature comprises a seasonal design.

13. The window shutter sleeve of claim 2 wherein the decorative feature comprises a holiday design.
